(19) United States
(12) Patent Application Publication
(10) Pub. No.: US 2011/0318643 A1
(43) Pub. Date: Dec. 29, 2011

(54) ND/OR CLOSED BATTERY, AND AN OPEN AND/OR CLOSED BATTERY INCLUDING A PERMANENT PASTING MATERIAL

(75) Inventors: Nicolas Clement, Charavines (FR); Daniel Doillon, Creysse (FR); Sylvie Bayle, Bayac (FR); Nicolas Benattar, Bergerac (FR)

(73) Assignee: BERNARD DUMAS, CREYSSE (FR)

(21) Appl. No.: 13/126,952

(22) PCT Filed: Oct. 29, 2009
(86) PCT No.: PCT/IB2009/054801

§ 371 Date: Sep. 16, 2011

(30) Foreign Application Priority Data
Oct. 29, 2008 (FR) 08 06003

(51) Int. Cl. H01M 2/16; B32B 38/00

(52) U.S. Cl. 429/247; 429/252; 156/60

(57) ABSTRACT

A permanent pasting sheet for an open and/or sealed battery, the material including glass microfibers that withstand acid electrolytes and a hydrophilic binder that withstands acid electrolytes, wherein the fiber material has a Cobb₆₀ degree, determined using the standard ISO 535, that is greater than or equal to three times its weight.

The present invention relates to a fiber material in the form of a permanent pasting sheet, in particular for an open and/or sealed battery, and it also relates to an open and/or sealed battery including a material in the form of a permanent pasting sheet, and to a method of pasting an electrode grid using said fiber material.

Lead acid batteries are made up of a plurality of cells each comprising a positive electrode plate and a negative electrode plate separated by a three-dimensional separator that is porous and insulating (in general an extruded polymer film specially designed for an open battery application or a separator of glass microfibers for application in sealed batteries), the cell being immersed in an acid electrolyte (generally dilute sulfuric acid). In general, open batteries contain a liquid electrolyte, whereas in sealed batteries the electrolyte may be in the form of a gel or absorbed in microporous material. Electrode plates are lead-based grids coated in a paste of a specific active material based on lead/lignin/mineral fibers/acid, possibly together with other ingredients that are specific to the battery manufacturer for the purpose of ensuring battery operation and cyclability (durability), i.e. allowing the battery to perform a certain number of charge/discharge cycles over time. The active material is applied by pasting grids, which is done by continuously depositing active material on a continuous grid while applying a so-called “pasting” paper on at least one of its faces, thereby helping to retain said material on the grid during fabrication and handling; the continuous grid with said paper is subsequently cut up to the format required for the electrodes. Subsequently, the electrodes are arranged and put into place when the battery is assembled.

The following documents: FR 2 677 672; EP 0 267 092; US 2008/199769; JP 61-096659; JP 2001-176481; JP 08-130001; JP 63-152850; FR 2 537 921; DE 40 36 233; and DE 29 10 203 describe examples of sheets suitable for use as separators in batteries or storage batteries.

Usual pasting papers for open batteries are cellulose papers weighing about 10 grams per square meter (g/m²) to 15 g/m², and they need to present good mechanical strength to allow them to be handled, in particular while being used in pasting methods.

Usual pasting papers for sealed batteries are cellulose papers or papers based on glass microfibers and that may include synthetic fibers.

Such pasting papers subsequently break down quickly in the battery on coming into contact with the acid electrolyte, even though that may disturb proper operation of the battery. The residues and breakdown products of the paper are set into motion in particular by convection phenomena within the battery as a result of electrolysis reactions, bubbling of the electrolyte, and thermal stirring driven by exothermic chemical reactions. The residues can thus interfere with chemical reactions and/or clog the electrodes, thereby degrading the cyclability capacity of the battery and thus shortening its lifetime.

Furthermore, with an open battery, the acid and the pasted plates are free within the battery. The function of mechanically holding the active material as performed by the paper disappears as a result of the paper breaking down in the acid, thereby having the consequence of said active material also breaking down, dropping to the bottom of the battery, and sometimes giving rise to loss of capacity and also to short circuits and premature corrosion; this therefore also has a negative effect on the cyclability of the battery.

In order to improve cyclability of open batteries, certain manufacturers associate a glass web with the cellulose pasting paper, however that requires an additional operation for adding the glass web to the paper. Although the glass web remains in contact with the grid, it does not enable the grid to be pasted so it continues to be necessary to use a pasting paper made of cellulose.

In patent application US 2008/0145066 A1, it is proposed to improve the cyclability of a lead/acid battery that includes a valve, in particular by using a pasting paper that includes an absorber of heavy metals that is a rare-earth compound, e.g. cerium hydroxide. The pasting papers described in Examples 3 and 4, page 5 of that patent application are based on glass microfibers and include as a binder organic fibers that are either microfibrillated cellulose or synthetic hot-melt fibers.

The binder used is thus attacked by the acid electrolyte and there may also be problems with battery operation associated with the degradation of the paper and the lack of retention of the active material paste.

An object of the present invention is to solve the cyclability problems of open batteries that result from the prior art pasting papers used in those batteries, and to improve the method of pasting plates for sealed batteries based on pasting paper made of glass microfibers.

To solve the problems of the prior art, the inventors have had the idea of proposing that the pasting material, unlike those used in the prior art, should not be destructible once it has been put into place in its application medium within acid electrolytes, and thus that it should be permanent. There are thus no residues or degradation products of the pasting material to impede the operation of the battery.

Furthermore, said material of the invention is also capable of withstanding a temperature of 75° C., the temperature that is recommended by battery manufacturers.

In addition, the material proposed by the invention is also capable of acting on the cyclability of an open battery because it enables the pasting active material to be held mechanically and more securely close to its initial position within the battery, thereby serving to further improve the lifetime of an open battery, since the active material is held and cannot break down and drop to the bottom of the battery, giving rise to loss of capacity, short circuits, and premature corrosion, as occurs in the prior art.

Furthermore, because of its high degree of porosity, its hydrophilic nature, and the fact that it is permanent, said material of the invention may serve to limit stratification phenomena in the free acid contained in the battery. In the prior art, the stratification phenomenon leads to the acid being distributed non-uniformly over the surfaces of the plates, and it is identified as one of the main modes of failure of open batteries.

Furthermore, the increased mechanical strength of this pasting material may enable the pasting paper to behave well on continuous pasting lines, as a replacement for cellulose paper.

In a first aspect of the invention, there is provided a permanent pasting material for a battery, in particular an open and/or sealed battery, which material is a fiber material in sheet form comprising glass microfibers and a hydrophilic binder that presents the ability to withstand acid electrolytes, the binder serving in particular to prevent the microfibers from separating and becoming dispersed in the electrolyte. The binder can thus contribute to conferring on said material the level of water absorbency that is required to enable it to be fully impregnated with electrolyte, and also to increase mechanical strength to enable it to replace cellulose pasting paper on pasting lines that operate continuously and without requiring any reduction in the rate of pasting.

The battery may be a lead/acid battery. The acid electrolyte may be sulfuric acid, in particular dilute sulfuric acid.

The material is said to be “permanent” insofar as it does not break down significantly or quickly, and withstand acids, under usual operating conditions. In particular, the permanent material may remain intact for a duration that is not less than the lifetime of the battery. It may therefore remain in contact with the electrode grid for a duration that is not less than the lifetime of the battery.

The material is said to be “hydrophilic” in that it has a good capacity for absorbing the liquid electrolyte, i.e. for filling all of its pores. This hydrophilic nature of said material may be characterized by its Cobb₆₀ degree, i.e. the water absorption capacity of said material, as determined using the standard ISO 535 (water, 1 minute (min), 23° C.), and it is expressed in g/m². According to the invention, said material has a Cobb₆₀ degree that is greater than or equal to three times its weight. For example a material having a weight of 35 g/m² should have a Cobb₆₀ degree of not less than 105 g/m².

Mechanical strength is said to be “increased” in that the material presents mechanical strength that is high relative to its weight. This strength may be characterized by its traction strength (in application of the standard ISO 1924-1-1992 (10 millimeters per minute (mm/min))). According to the invention, said material may present traction strength standardized for 100 g/m² (strength divided by weight and multiplied by 100) that is greater than 4 decanewtons per inch (daN/in).

More particularly, said glass microfibers may present a diameter less than 5 micrometers (pm). They may usually be used for making battery separators.

More particularly, said hydrophilic binder that withstands acid may be cured, in particular hot-cured. It may be selected from polymer binders that are acrylic-, epoxy-, phenolic-, polyester-, and polyurethane-based. Preferably, an acrylic-based polymer binder is selected. In use, these binders may be in the form of a latex (a stabilized polymer emulsion in an aqueous medium); they may be cured, in particular hot-cured, during the method of fabricating said material.

Said material of the invention may preferably further include glass fibers in the form of cut glass filaments that withstand acid electrolytes, and/or synthetic hot-melt fibers that withstand acid electrolytes. Such filaments and synthetic fibers may act in particular on the mechanical strength of said material, which material must be suitable for being handled, and where appropriate, they may make it easier to fabricate said material.

More particularly, said material of the invention may comprise, in dry weight:
10 to 99.9 parts of said glass microfibers;
0.1 to 50 parts of said binder;
0 to 70 parts of said cut glass filaments; and
0 to 90 parts of said synthetic hot-melt fibers;

for a total of 100 parts.

Still more particularly, and preferably, said material of the invention may comprise in dry weight:
65 to 95, e.g. 65 to 80 parts of said glass microfibers;
5 to 15, e.g. 5 to 10 parts of said binder;
0 to 5 parts of said cut glass filaments; and
0 to 20, e.g. 15 to 20 parts of said synthetic hot-melt fibers;

for a total of 100 parts.

More particularly, said material of the invention may be such that said cut glass filaments present a diameter greater than or equal to 5 μm, and a length greater than or equal to 3 millimeters (mm).

More particularly, said material of the invention may be such that said synthetic fibers are selected from two-component fibers presenting a polyester core and an outer layer of hot-melt (co)polyester having a melting point of 130° C., their diameter preferably being greater than or equal to 5 μm, and their length greater than or equal to 3 mm. The melting temperature of the outer portions of two-component fibers as described above may be 110° C.

More particularly, said material of the invention may be such that it presents a weight that is greater than or equal to 10 g/m², preferably greater than or equal to 20 g/m², preferably lying in the range 30 g/m² to 120 g/m², e.g. in the range 30 g/m² to 60 g/m², with it being possible to envisage weights that are higher.

Said material of the invention may preferably present porosity as determined using the standard BCI IV 34-1 (empty volume) that is greater than or equal to 85%, preferably greater than or equal to 90%.

The material of the invention may be obtained industrially, preferably using a wet method, i.e. a paper-making method that consists in putting the glass microfibers, and where appropriate the cut glass filaments and/or the synthetic hot-melt fibers, into suspension in an aqueous medium (possibly together with certain additives that are usual in such a method and present in very small quantities), and then the fiber sheet is formed by draining the mixture on the cloth of a paper-making machine, with the binder being applied subsequently in the form of an aqueous emulsion (latex) on/in said fiber sheet, and then the resulting material is dried at temperatures of at least 100° C. Said fiber sheet may preferably be dried at a temperature suitable for enabling said binder to be cured, if the binder is curable, in particular a temperature of about 150° C.

In another aspect of the invention, there is provided a battery, in particular an open and/or sealed battery, which battery includes a material in the form of a permanent pasting sheet.

Said material, in the form of a permanent pasting sheet in said battery, is preferably the pasting fiber material as described above.

The invention also provides a method of pasting an electrode grid for a battery, in particular for an open and/or sealed battery, with an active material paste, which method is characterized by the fact that it uses a fiber material in the form of a permanent pasting sheet (capable of withstanding acid electrolytes), as described above.

The invention can be better understood with the help of the following non-limiting examples presenting an embodiment of a fiber material for a permanent pasting sheet.

### EXAMPLE 1 OF THE INVENTION

In the laboratory, an aqueous medium was put into suspension within a chest of glass microfibers having a mean diameter less than or equal to 1 μm, e.g. of 0.8 μm, and capable of withstanding acid electrolytes (such fibers are generally used for battery separators). A fiber sheet was formed by draining the suspension on a laboratory former and then drying the sheet at about 150° C.

An acrylic polymer binder in the form of an aqueous emulsion (latex) was applied on one of the faces of the sheet, and it spread by capillarity into the mass of fibers making up the mat of the sheet.

The material as obtained in that way was then dried at 150° C. for 15 min, the drying serving to eliminate the water delivered while applying the aqueous emulsion and serving to cure said polymer.

After drying, the material comprised in dry weight: 95 parts of glass microfibers and 5 parts of binder.

### EXAMPLE 2 OF THE INVENTION

A sheet was made on an industrial paper-making machine. In an aqueous medium within a chest, a suspension was made of glass microfibers having a diameter less than or equal to 1 μm, e.g. of 0.8 μm, and capable of withstanding acid electrolytes (microfibers usually used for battery separators) and of cut glass filaments (diameter 11 μm, length 6 mm), capable of withstanding acid electrolytes. A fiber sheet was formed by draining the suspension on the cloth of the paper-making machine. The sheet was dried at about 150° C.

Dried sheet formats were taken from the outlet of the machine suitable for acting as supports.

In the laboratory, an acrylic polymer binder in the form of an aqueous emulsion (latex) was applied on one of the faces of those formats and it spread into the mass of fibers constituting the mat by capillarity.

The material obtained in that way was subjected to drying at 150° C. for 15 min, thereby, as in Example 1, eliminating the water delivered during application of the aqueous emulsion and curing said polymer.

After this drying, the material comprised, in dry weight: 20 parts of cut filaments, 75 parts of glass microfibers, and 5 parts of binder.

### EXAMPLE 3 OF THE INVENTION

A sheet was made on an industrial paper-making machine. In an aqueous medium within a chest, a suspension was made of glass microfibers having a diameter less than or equal to 1 μm, e.g. of 0.8 μm, and capable of withstanding acid electrolytes (microfibers usually used for battery separators), and of synthetic two-component hot-melt fibers of polyester/copolyester (diameter: 10 μm, length: 5 mm), capable of withstanding acid electrolytes. A fiber sheet was formed by draining the suspension on the cloth of the machine. The sheet was dried at about 150° C.

Dried sheet formats were taken from the outlet of the machine for use as supports.

In the laboratory, an acrylic binder in the form of an aqueous emulsion (latex) was applied to one of the faces of those formats, which binder spread into the mass of fibers forming the mat by capillarity.

The material as obtained in that way was subjected to drying at 150° C. for 15 min, thereby, as in Example 1, eliminating the water delivered during the application of the aqueous emulsion, and curing said polymer.

After drying, the material comprised in dry weight: 14 parts of synthetic fibers, 81 parts of glass microfibers, and 5 parts of binder.

### EXAMPLE 4 OF THE INVENTION

The pasting material was made on an industrial machine.

In an aqueous medium within a chest, a suspension was formed of glass microfibers having a mean diameter less than or equal to 1 μm, e.g. of 0.8 μm, and capable of withstanding acid electrolytes (microfibers usually used for battery separators), and of synthetic two-component hot-melt fibers of polyester/copolyester (diameter: 10 μm, length: 5 mm), capable of withstanding acid electrolytes. A fiber sheet was formed by draining the suspension on the cloth of the paper-making machine.

An aqueous emulsion of an acrylic polymer binder was applied on one of the faces of said sheet in a fabrication line in such a manner as to spread said binder by capillarity within the fiber mass of the mat of the sheet. The concentration of the emulsion was such that the binder content in the resulting material lay in the range 10% to 12% dry weight.

The sheet was dried at about 150° C. Drying serves to remove the water contained in the fiber mat and then to cure said acrylic polymer so as to impart great mechanical strength thereto.

After drying, the material as obtained in that way comprised, in dry weight: 14 parts of synthetic fibers, 75 parts of glass microfibers, and 11 parts of binder.

The physical characteristics, the mechanical strength, and the ability to withstand acid electrolytes of said material of Examples 1 to 5 are set out in Table 1, with the manner in which the tests were performed and comments on the results being set out below.

### REFERENCES AND DESCRIPTIONS OF THE TESTS USED

The tests were performed on the fiber material dried in compliance with ISO (International Standards Organization) or BCI (Battery Council International) standards.
Weight was measured using the standard ISO 536-1995.
The Cobb₅₀ degree was determined using the standard ISO 535 (water, 1 min, 23° C.)
Thickness was determined using the standard ISO 9073-2 1989/07/01, under 2 kilopascals (kPa).
Porosity (empty volume) was calculated using the standard BCI IV 34-1.
Mechanical strength in traction was determined using the standard ISO 1924-1—1992 (10 mm/min).
Breaking elongation (%) was measured using the standard ISO 1924-2: 1994.
The mechanical strength of said material in a wet medium (aqueous medium) was determined using the following test: a disk of said material was immersed in 3 centimeters (cm) of water at 23° C. and held down on the bottom by a metal ring having a diameter of 7 cm. A magnetic bar weighing 4.5 grams (g) and presenting a length of 3.5 cm was set into motion (at about 200 revolutions per minute (rpm)) on the sample held down on the bottom. The length of time taken by the sample to break down under those conditions was then measured; with the materials of these examples, no crumbling was observed, it was merely observed that they began to be attacked on the surface after being tested for several days (see Table 1, number of days after which the sample was attacked).
The resistance of the material to sulfuric acid was measured using the test BCI XII 34-1, which test is usually used for battery separators based on glass microfibers. For the materials of Examples 1 to 5, it was found that the measured weight loss of the material in the acid medium was less than 1%, and the extractable metals content was in accordance with the contents usually measured for glass microfibers:
   (Cu<5 parts per million (ppm), Cr<5 ppm, Fe<50 ppm, Mn<5 ppm, Ni<5 ppm, Al<900 ppm, Zn<20 ppm).
   It is thus shown that the binder of the materials of the invention, in comparison with usual battery separators based on glass microfibers but without any binder, do not increase the extractable content as tested by the test BC XII 34-1.

Furthermore, given their natures, said materials constituting the examples withstand high temperatures well, in particular temperatures of up to at least 75° C.

The pasting materials of the invention may therefore present good mechanical strength, good ability to withstand high temperatures, good ability to withstand acids, they are suitably hydrophilic, and they present high porosity.

TABLE 1

| Examples | 1 | 2 | 3 | 4 |
|---|---|---|---|---|
| Weight (g/m²) | 40 | 35 | 35 | 41.2 |
| Cobb₆₀ (g/m²) | 160 | 190 | 175 | 160 |
| Thickness (mm) | 0.24 | 0.21 | 0.21 | 0.24 |
| Porosity (%) | 93.3 | 93.3 | 93.3 | 92.2 |
| Traction strength | | | | |
| daN/in | 1.6 | 1.9 | 2.2 | 3.0 |
| (decanewtons per | 0.63 | 0.75 | 0.87 | 1.18 |
| centimeter (daN/cm)) | | | | |
| Elongation at rupture (%) | 1.2 | 0.9 | 1.15 | 1.6 |
| Abrasion test in a wet | | | | |
| medium | | | | |
| Degradation: | No | No | No | No |
| Number of days after | >4 | >7 | >7 | >7 |
| which the sample was | | | | |
| attacked | | | | |
| Resistance to acid | | | | |
| Weight loss (%) | <1% | <1% | <1% | <1% |

1-17. (canceled)

18. A fiber material in the form of a permanent pasting sheet for an open and/or sealed battery, the material comprising glass microfibers that withstand acid electrolytes and a hydrophilic binder that withstands acid electrolytes, wherein the fiber material has a Cobb₆₀ degree, determined using the standard ISO 535, that is greater than or equal to three times its weight.

19. A material according to claim 18, wherein said glass microfibers have a diameter less than 5 μm.

20. A material according to claim 18, wherein the binder is cured.

21. A material according to claim 20, wherein the binder is hot-cured.

22. A material according to claim 18, wherein said binder is selected from polymer binders that are acrylic-, epoxy-, phenolic-, polyester-, and polyurethane-based.

23. A material according to claim 18, wherein said material further includes cut glass filaments that withstand acid electrolytes and/or synthetic hot-melt fiber that withstand acid electrolytes.

24. A material according to claim 18, wherein said material comprises, in dry weight for a total of 100:
10 to 99.9 parts of said glass microfibers;
0.1 to 50 parts of said binder;
0 to 70 parts of said cut glass filaments; and
0 to 90 parts of said synthetic hot-melt fibers.

25. A material according to claim 24, wherein said material comprises, in dry weight for a total of 100:
65 to 80 parts of said glass microfibers;
5 to 10 parts of said binder;
0 to 5 parts of said cut glass filaments; and
15 to 20 parts of synthetic hot-melt fibers.

26. A material according to claim 23, wherein said cut glass filaments have a diameter greater than or equal to 5 μm and a length greater than or equal to 3 mm.

27. A material according to claim 23, wherein said synthetic fibers are selected from two-component fibers having a polyester core and an outer layer of (co)polyester having a melting point below 130° C., of diameter that is greater than or equal to 5 μm and of length that is greater than or equal to 3 mm.

28. A material according to claim 18, wherein said material presents a weight greater than or equal to 10 g/m².

29. A material according to claim 30, presenting a weight greater than or equal to 20 g/m².

30. A material according to claim 28, presenting a weight lying in the range 30 g/m² to 120 g/m².

31. A material according to claim 32, said porosity being in the range 30 g/m² to 60 g/m².

32. A material according to claim 18, wherein said material presents porosity as determined using the standard BCI IV 34-1 that is greater than or equal to 85%.

33. A material according to claim 32, said porosity being greater than or equal to 90%.

34. A material according to claim 18, wherein said material presents mechanical strength divided by weight in g/m² and multiplied by 100 that is greater than or equal to 4 daN/in.

35. A material according to claim 18, that is obtained by a wet method.

36. A fiber material in the form of a permanent pasting sheet for an open battery, the material comprising glass microfibers that withstand acid electrolytes and a hydrophilic binder that withstands acid electrolytes, wherein the fiber material presents a Cobb₆₀ degree, determined using the standard ISO 535, that is greater than or equal to three times its weight.

37. An open and/or sealed battery including a fiber material constituting a permanent pasting sheet in accordance with claim 18.

38. A method of pasting an electrode grid for an open and/or sealed battery with a paste of active material, wherein the method uses a fiber material constituting a permanent pasting sheet as described in claim 18.
